(19) United States
(12) Patent Application Publication
(10) Pub. No.: US 2013/0239746 A1
(43) Pub. Date: Sep. 19, 2013

(54) CENTRIFUGAL PENDULUM

(71) Applicant: SCHAEFFLER TECHNOLOGIES AG & CO. KG, Herzogenaurach (DE)

(72) Inventor: Parviz Movlazada, Rastatt (DE)

(73) Assignee: Schaeffler Technologies AG & Co. KG, Herzogenaurach (DE)

(21) Appl. No.: 13/888,717

(22) Filed: May 7, 2013

Related U.S. Application Data
(63) Continuation of application No. PCT/DE2011/001908, filed on Oct. 28, 2011.

(30) Foreign Application Priority Data
Nov. 8, 2010 (DE) 102010050715.6

(51) Int. Cl. F16F 15/14

(52) U.S. Cl. CPC F16F 15/145
USPC 74/574.2

(57) ABSTRACT

A rotational speed-adaptive centrifugal force pendulum for a shaft that can be rotated about an axis, having a pendulum flange on which at least two axially opposite absorber masses that are connected to each other via a spacing element are arranged. The absorber masses and/or the pendulum flange of the centrifugal force pendulum have at least one cutout in which the spacing element of the absorber mass is guided. The cutout is designed as a curve that deviates from a circle or a circular segment starting from a neutral position, by a radius increase of the cutout in one region starting from the neutral position and by a radius reduction of the cutout in the other region starting from the neutral position.

### CROSS-REFERENCE TO RELATED APPLICATIONS

This application is a continuation of International Patent Application PCT/DE2011/001908 filed Oct. 28, 2011 and claims priority from German Patent Application No. 10 2010 050 715.6 filed Nov. 8, 2010, which applications are incorporated herein by reference in their entireties.

### FIELD OF THE INVENTION

The invention relates to a centrifugal pendulum, especially a centrifugal pendulum for damping torsional oscillations of a drive train, for example, a drive train of a vehicle with a combustion engine.

### BACKGROUND OF THE INVENTION

DE 198 31 160 Al discloses a speed-adaptive oscillation absorber for a shaft rotating around an axis. In this case, an inertial mass of the oscillation absorb executes a purely translational motion relative to the hub part. This is achieved by a mounting that is also referred to as a parallel bifilar suspension. Since the inertial mass is additionally a rigid element, each of the points assigned to the inertial mass executes an identical motion along a motion path B running through the respective point P.

### BRIEF SUMMARY OF THE INVENTION

The object of the present invention is to provide an improved centrifugal pendulum.

The invention is a speed-adaptive centrifugal pendulum provided for a shaft rotating around an axis, having: a pendulum flange on which at least two axially opposite absorber masses connected to each other and at a distance from each other are mounted, whereby the absorber masses and/or the pendulum flange of the centrifugal pendulum has at least one cutout, in which the spacer element and thus the absorber mass is guided, whereby the cutout is formed, starting from a neutral position, by a circle or a curve deviating from a circular segment, by an increase in the radius of the cutout in one area starting from the neutral position, whereby the neutral position is the position in which the spacer element of the absorber mass contacts the cutout with an oscillation angle of the centrifugal pendulum of 0°.

The centrifugal pendulum has the advantage that, because the cutout is formed by a circle and/or a curve deviating from a circular segment, a sliding of a spacer element guided in the breakout, like a pin or a roller, can be counteracted and thus, sliding friction associated with it.

In one embodiment of the invention, the radius of the outer contour and/or inner contour of the breakout is designed so it is enlarged in at least one section and/or reduced in at least one section, whereby the radius of the outer contour and/or the inner contour is enlarged or reduced at one or both ends of the cutout. The outer contour and the inner contour of the cutout can have the same curve and/or contour curve or a different contour curve.

According to another embodiment of the invention, the radius of the outer contour and/or inner contour of the cutout is designed so it is enlarged or reduced in at least one section starting from a neutral position or point.

In another embodiment of the invention, the cutout is designed in such a way that the absorber mass can execute a translational or rotary motion, whereby the at least one cutout especially has a non-symmetrical curve or path curve. This means that the absorber mass does not follow a symmetrical path curve, but rather a non-symmetrical path curve as is shown in the following, e.g., in FIGS. 2 and 4.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic representation of the principle of a centrifugal pendulum of the invention;

FIG. 2 is a first embodiment of the centrifugal pendulum of the invention;

FIG. 3 is a cross section view A-A of the centrifugal pendulum as shown in FIG. 1;

FIG. 4 is a second embodiment of a centrifugal pendulum of the invention;

FIG. 5 is a cross section view A-A of the centrifugal pendulum as shown in FIG. 4;

FIG. 6 is a roller cutout of a pendulum flange of the centrifugal pendulum of the invention as shown in FIG. 4; and,

FIG. 7 is an assigned roller cutout of an absorber mass of the centrifugal force of the invention as shown in FIG. 4.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

The basic principle of a centrifugal pendulum is that an absorber mass pair is linked with a pendulum flange as a pendulum. Since the absorber mass pair is located in the centrifugal field, its natural frequency increases proportionally to the rotation speed. A design of the pendulum geometry makes it possible to always keep the natural frequency of the pendulum equal to an engine speed order. The term absorber order is used for this. The absorber order is q=√L/l, wherein l is the pendulum length or the radius of curvature of the pendulum running path in the fixed-shaft coordinate system and L is the distance from the center of curvature of this running path from the axis of rotation. The absorber order is determined on the basis of the engine speed orders k, depending on the number of engine cylinders. For example, for a 4-cylinder engine, q=2.

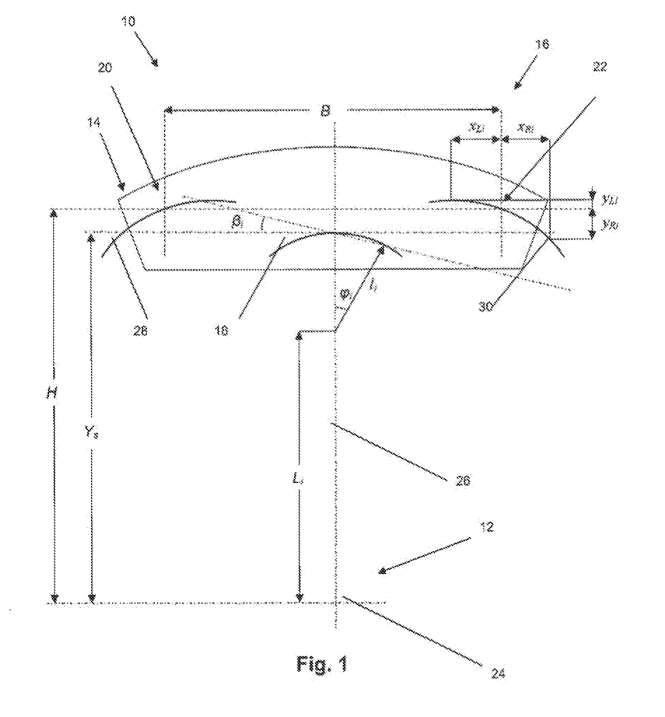

FIG. 1 shows a schematic illustration of the principle of a centrifugal force 10 of the invention.

The invention relates to a centrifugal pendulum for damping torsional oscillations of a drive train, especially a drive train in a vehicle, e.g., a vehicle with a combustion engine. However, the invention is not restricted to this application.

In this case, a centrifugal pendulum 10 is provided that has an absorber order curve that can be regulated in design depending on an oscillation angle. In addition, the centrifugal pendulum 10 simultaneously has an advantageous trapezoidal arrangement, i.e., the construction space can be used optimally.

The centrifugal pendulum 10 has a pendulum flange 12 and several absorber masses 14 arranged in pairs. The pendulum length, the pendulum spacing and the turning angle of the absorber masses are dependent on the oscillation angle, whereby an influence of the absorber arrangement (constant or changing) is possible. A turning angle of the absorber mass 14 is also provided.

This is achieved in that the geometric dimensions, i.e., the distance L of the oscillation center and the oscillation length l of the absorber mass and the turning angle β of the absorber mass, are variable or constant depending on the oscillation angle φ of the pendulum. This means that at least one of the following conditions 1.)-4.) must be fulfilled:
1.) Distance of the oscillation center L=f(φ), wherein f(φ) is a function of the pendulum oscillation angle or L=constant;
2.) Oscillation length of the absorber mass l=f(φ); or l=constant;
3.) Turning angle of the absorber mass β=f(φ); ⊕=0.

In order to achieve a centrifugal pendulum 10 that is variable or constant depending on the oscillation angle φ, these three variables, i.e., the distance of the oscillation center L, the oscillation length of the absorber mass l and the turning angle β of the absorber mass can be varied selectively using the oscillation angle of the absorber mass pair φ (center of gravity of the mass). In this way, a specific path shape 18 of the mass center of gravity of pendulum 16, as shown in FIG. 1, is generated with a corresponding rotation of the absorber mass 14.

By using a selective variation, any desired path shape 18 for the mass center of gravity can be achieved with a corresponding rotation of the absorber mass pair and thus, the desired absorber arrangement curve. In this case, the absorber mass 14 executes superimposed translational and rotary motions, i.e., the absorber mass 14 will move with its center of gravity along a path 18 and simultaneously turn around its own center of gravity.

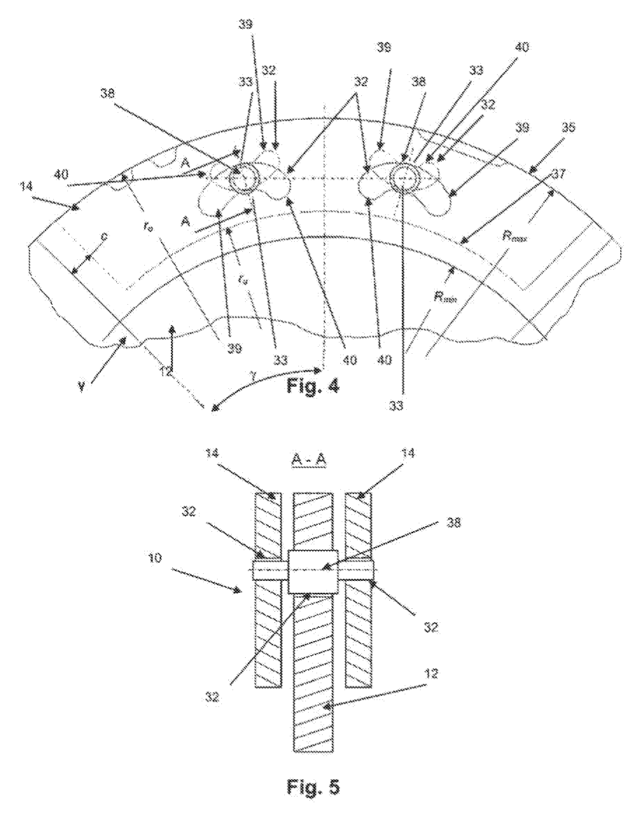

In principle, the motions of the absorber mass 14 can be achieved by the motion paths of two points 20, 22 of the absorber mass 14, the length of which (x_{Li}, y_{Li}, x_{Ri}, y_{Ri}) is determined by the geometric variables H and B as shown in FIG. 1. In this case, H is the distance of the first and/or second point 20, 22 of the absorber mass 14 from the oscillation center 24, in this case the axis of rotation of the pendulum disk and/or the pendulum flange 12 (center point of the disk in FIG. 1). B is the distance of the two points 20, 22 from each other. For example, in FIG. 1, the points 20, 22 each have the same distance from the center axis 26, which runs through the oscillation center 24 or, in other words, the two points 20, 22 are symmetrical to the center axis 26. The respective motion path 28 and/or 30 of the point 20 and/or 22 is asymmetrical or does not run symmetrically. Because of this asymmetric or non-symmetrical running of the respective motion path 28 and/or 30 of the point 20 and/or 22 of the absorber mass 14, the absorber mass 14 executes superimposed translational and rotary motions. The cutouts or roller cutouts in an absorber mass 14 and/or a pendulum flange 12 do not follow the symmetrical curve of the motion path. This also applies to the cutouts or roller cutouts shown in FIG. 4.

In this case, the coordinates X_{Li}, Y_{Li}, X_{Ri}, Y_{Ri} of the motion paths 28, 30 of the two points 20, 22 of the absorber mass 14 in FIG. 1 are calculated as follows, for example:

x_{Ri}=0.5B(cos βᵢ−1)+l, sin φᵢ+(H−Yₛ)sin βᵢ

x_{Ri}=0.5B(1−cos βᵢ)+lᵢsin φᵢ+(H−Yₛ)sin βᵢ

y_{Ri}=0.5B sin βᵢ−Lᵢ−lᵢ cos φᵢ−(H−Yₛ)cos βᵢ+H

y_{Ri}=0.5B sin βᵢ+Lᵢ+lᵢ cos φᵢ+(H−Yₛ)cos βᵢ−H

wherein
φᵢ=Oscillation angle of the pendulum
β₁=Turning angle of the mass and/or absorber mass (mass element)
Yₛ=Distance of mass center of gravity (mass element)
L₁=Distance of the oscillation center
l₁=Oscillation length of the mass and/or absorber mass (mass element)
H=Distance of the first or second point of the absorber mass from the oscillation center
B=Distance of the first and second point from each other

A constant absorber order q=constant of the centrifugal pendulum 10 is then present if the path 18 of the mass center of gravity of an absorber mass pair is a circular segment, i.e., if L=constant and l=constant. The mass turning β depends on the oscillation angle φ:

$$β = arcsin [ \frac{l \cdot sin ϕ}{\sqrt{{l}^{2} + {L}^{2} + 2 \cdot l \cdot L \cdot cos ϕ}} ]$$

This special case supplies a constant absorber order.

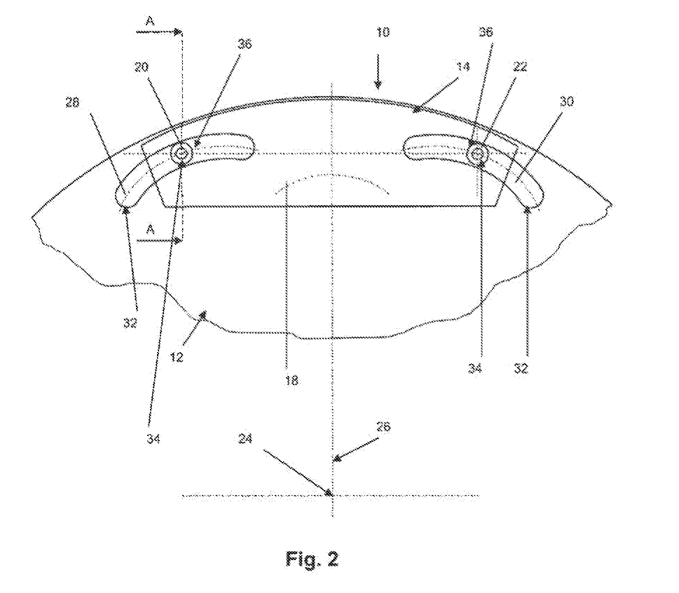

FIG. 2 shows a cutout of a centrifugal pendulum 10 of a first embodiment of the invention. As explained in FIG. 2, a pendulum flange 12 is shown, on which at least one, or several, pairs of absorber masses 14 are arranged.

In this cutout in FIG. 2, an absorber mass 14 is mounted on the pendulum flange 12. As already described with reference to FIG. 1, in principle, the motions of the absorber mass 14 is achieved by the motion paths 28, 30 of two points 20, 22 of the absorber mass 14, the position of which is determined by the geometric variables H and B. As shown in FIG. 2, cutouts or roller cutouts 32 corresponding to the motion paths 28, 30 are now formed in the pendulum flange 12.

In a first embodiment, one absorber mass 14 is arranged on an opposite side of the pendulum flange 12. The two absorber masses 14 are suspended by means of two pins 34 and bearings 36 mounted on them in roller cutouts of the pendulum flange. Here, one pin 34 and its bearing 36 form a spacer element for suspension and guiding of the absorber mass 14 in the respective cutout 32. The bearings 36 are advantageous because they cause rolling friction instead of sliding friction. Provision of the bearings 36 is optional. The pins 34 connect the two absorber masses to form an absorber mass pair. As previously described, the cutouts 32 or recesses on the pendulum flange 12 have the design or shape of the motion paths 28, 30 for two points 20, 22 of the absorber mass 14, as previously described in FIG. 1. The curve of the motion path 18 of the absorber mass 14 center of gravity is also shown in FIG. 1, as well as the center axis 26 through which the oscillation center 24 runs. The spacer element and/or, in this case, a combination of pin and bearing, preferably, has a diameter that is smaller than the width of the respective cutout 32 in which it is held since otherwise this could lead to undesirable friction.

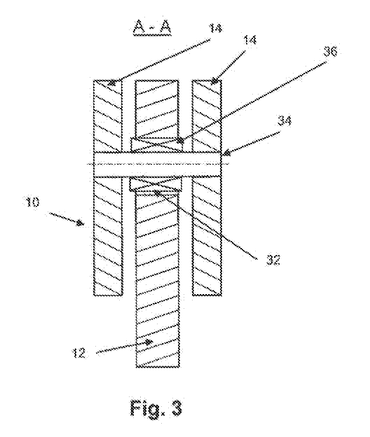

FIG. 3 shows a cross section A-A through the centrifugal pendulum 10 shown in FIG. 2. A respective absorber mass 14 is provided on both sides of the pendulum flange 12 or the pendulum disk. As previously shown in FIG. 2, the pendulum flange 12 has two cutouts 32 that have the design of the motion paths 28, 30 for two points 20, 22 of the absorber mass 14 and/or follow their curve. A pin 34 is held in the respective cutout 32 and has a bearing 36. For example, the bearing 36 can be a roller bearing, thrust bearing or friction bearing, to name three examples. In addition, the pins 34 in the example shown in FIG. 3 are each connected on both sides with an absorber mass 14.

FIG. 4 shows a cutout of a centrifugal pendulum 10 wherein a pendulum flange 12 is shown on which at least one or more pairs of absorber masses 14 are mounted. The absorber masses 14 are suspended in cutouts 32 or recesses on the respective absorber mass 14 and the pendulum flange 12 by means of rollers 38 as spacer elements. The spacer elements and/or roller 38 preferably have a smaller diameter than the width of the respective cutout 32 in which they are held.

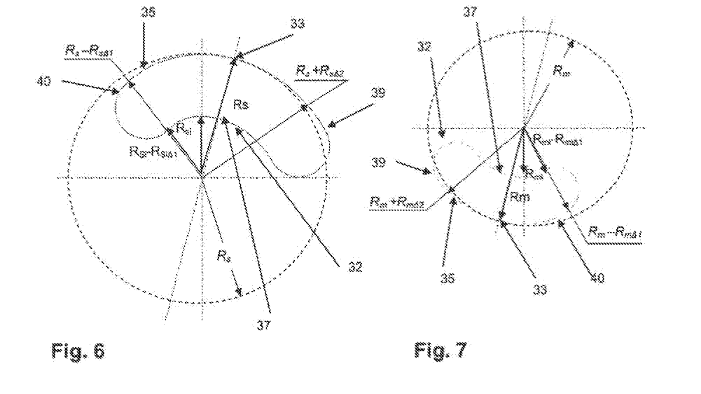

A cutout 32 of the pendulum flange 12 is assigned to a cutout 32 of the absorber mass 14, whereby the two cutouts 32 are arranged over each other. As shown in FIG. 4, the respective cutout 32 on the pendulum flange 12 and the assigned cutout 32 on the absorber mass 14 are arranged with respect to each other in such a way that the respective roller 38, which is guided in the two cutouts 32 contacts the respective cutout 32 of the pendulum flange 12 and/or the absorber mass 14 in a neutral position and/or location 33, i.e., with an oscillation angle φ=0° (see also the following FIGS. 6 and 7). In this case, the respective cutout 32 on the pendulum flange 12 and the assigned cutout 32 on the absorber mass 14 are arranged with respect to each other as is explained in more detail in the following with the use of FIGS. 6 and 7, that respective areas 39 of the cutouts 32 of the pendulum flange 12 and the absorber mass 14, the radius Rₛ and/or Rₘ of which is enlarged in this area starting from the neutral position or location 33 are opposite each other. Correspondingly, areas 40 of the cutouts 32 of the pendulum flange 12 and of the absorber mass 14, the radius Rₛ and/or Rₘ of which is reduced in this area starting from the neutral position and/or location 33 lie opposite each other.

In FIG. 4, as an example, an absorber mass 14 is located on both sides of the pendulum flange 12, whereby in FIG. 4 the absorber mass 14 is shown on the front side of the pendulum flange 12. The absorber mass with its two cutouts on the reverse side of the pendulum flange 12 is arranged corresponding to the absorber mass 12 and its cutouts on the front side.

The centrifugal pendulum and/or the oscillation absorber arrangement 10 with regular absorber mounting curve can be produced with simple rollers, as well as, e.g., stepped rollers.

In order to minimize or prevent sliding on the roller pairs 38, the cutouts or roller cutouts 32 on the respective absorber mass 14 and the pendulum flange 12 are formed by a circular segment or curves deviating from a circular shape. The roller cutouts 32 on the mass 14 and the pendulum flange 12 are formed, for example, starting from the neutral location or starting from the neutral position 33, by increases in radius and reductions in radius R_{mΔ} and/or R_{sΔ} of a circle or curves deviating from a circular segment, as is also shown in FIGS. 6 and 7. In FIG. 4, roller pairs 38 are each located in the neutral position 33 in which the oscillation angle is φ=0°. In this case, one area 40 or one side of the cutout 32 of the pendulum flange 12 and/or of the absorber mass 14 is formed starting from the neutral position 33, by a circle or curve deviating from a circular segment using a reduction in radius and in the other area 39 or on the other side of the cutout 32 of the pendulum flange 12 and/or the absorber mass 14 is formed starting from the neutral position 33 by a circle or a curve deviating from a circular segment using a radius enlargement.

The outer contour 35 of the absorber mass 14 is formed, for example, by the circular segment with the center in the flange center and with the radius rₒ=Rₘₐₓ−c1, whereby, e.g., c1 ≧0. The inner contour 37 is formed, for example, by the circular segment with the radius rᵤ=Rₘᵢₙ+c2, whereby, e.g., c2≧0. The lateral contour is e.g., a straight line section that is parallel to the dividing axis γ and at a distance c from it, as shown in FIG. 4, whereby, e.g., c≧0.

In FIG. 4, the following apply:

Rₘₐₓ=maximum radius of an available construction space;

Rₘᵢₙ=minimum radius of an available construction space;

γ=dividing axis with dividing angle γ=360°/2n; and,

N=division n>0.

FIGS. 6 and 7 show an exemplary embodiment for a cutout 32 or roller cutout 32 for an absorber mass 14 and a pendulum flange 12. More specifically, FIG. 6 shows the respective cutout 32 of the pendulum flange of the centrifugal pendulum in FIG. 4 and FIG. 7 shows the respectively assigned cutout 32 of the absorber mass of the centrifugal pendulum in FIG. 4. As was already described, roller sections 32 are designed by a curve deviating from a circle to minimize or prevent sliding on the roller pairs 38. The roller cutouts 32 on an absorber mass 14 and a pendulum flange 12 can be formed by a curve deviating from a circle or circular segments as shown in FIGS. 6 and 7, by radius increases and radius reductions R_{mΔ} and/or R_{sΔ} starting from a neutral location or position 33 at which the oscillation angle φ=0°. A radius reduction or radius increase, is understood to mean, for example, a linear increase or decrease of the radius at a distance from the neutral location. Instead of a linear increase or decrease, a different behavior can also be selected with which the radius becomes larger or smaller with the distance from the neutral position. As shown in FIG. 4, the cutouts 32 of the pendulum flange 12 are arranged mirror inverted with respect to each other. In more precise terms, the two cutouts 32 of the pendulum flange can be arranged mirror inverted with respect to the center axis 26 through the oscillation center 24. Correspondingly, the two cutouts 32 of the respective absorber mass 14 can also be arranged mirror inverted with respect to each other, i.e., mirror inverted to the center axis 26 through the oscillation center 24.

The following apply in FIGS. 6 and 7:

Rₛ=Radius of the cutout or the recess on the flange; and,

Rₘ=Radius of the cutout or the recess on the mass and/or mass element.

In the roller cutout 32 shown in FIG. 6 of the pendulum flange of the centrifugal pendulum, as shown in FIG. 4, on both sides and/or in the right and left area of the neutral position 33, in which the oscillation angle φ=0° and one radius Rₛᵢ and one radius Rₛ of the roller cutout 32 is enlarged and one is reduced. More specifically, on one side and/or in one area 39 starting from the neutral position 33, the radius and/or in this case the outer radius Rₛ of the roller section 32 is enlarged, in this case by an amount R_{s←2}, so that Rₛ+R_{sΔ2} is true. On the other side and/or in the other area 40, starting from the neutral position 33 of the radius and/or, in this case the outer radius Rₛ of the roller cutout 32 is reduced, in this case by an amount R_{sΔ1}, so that Rₛ−R_{sΔ1} is true. The analogous is also true for inner radius Rₛᵢ of the roller cutout 32. The inner radius Rₛᵢ of the roller cutout 32, like the outer radius Rₛ is enlarged from the same amount starting from a neutral position 33 and in an area 39 and in the other area 40 starting from the neutral position 33, is reduced like outer radius Rₛ by the same amount (in FIG. 6 Rₛᵢ−R_{siΔ1}).

In the roller cutout 32 shown in FIG. 7 of the absorber mass of the centrifugal pendulum, as shown in FIG. 4, on both sides and/or in the right and left area of the neutral position 33, in which the oscillation angle φ=0° and one radius Rₘᵢ and one radius Rₘ of the roller cutout 32 is enlarged and one is reduced. That is, in one area 39 starting from the neutral position 33, the radius and/or in this case the outer radius Rₘ of the roller section 32 is enlarged, in this case by an amount R_{mΔ2}, so that Rₘ+R_{mΔ2} is true. In the other area 40, starting from the neutral position 33 of the radius and/or, in this case the outer radius Rₘ of the roller cutout 32 is reduced, in this case by an amount R_{mΔ1}, so that Rₘ−R_{mΔ1} is true. The analogous is also true for inner radius Rₘᵢ of the roller cutout 32. The inner radius Rₘᵢ of the roller cutout 32, like the outer radius Rₘ is enlarged from the same amount starting from a neutral position 33 and in an area 39 and in the other area 40 starting from the neutral position 33, is reduced like outer radius Rₘ by the same amount (in FIG. 7 Rₘᵢ−R_{miΔ1}).

The amount R_{m,sΔ1}, by which the radius Rₘ and/or Rₛ of the roller cutout 32 of the absorber mass and/or of the pendulum flange is reduced can be equal to or unequal to the amount R_{m,sΔ2}, by which the radius Rₘ and/or Rₛ of the roller cutout 32 of the absorber mass and/or of the pendulum flange is enlarged, i.e., R_{m,SΔ1}=R_{m,SΔ2} or R_{m,sΔ1}≠R_{m,SΔ2} or R_{mi,SiΔ1}=R_{mi,Si{2} or R_{mi,SiΔ1}R_{mi,SiΔ2}.

As previously shown in FIG. 4, now the respective roller cutout 32 on the pendulum flange 12 and the assigned roller section 32 on the absorber mass 14 are assigned to each other in such a way that the roller 38, which is guided in the two roller cutouts 32 contacts the respective roller cutout of the pendulum flange and/or the absorber mass in neutral position 33 at an oscillation angle φ=0° (see also FIGS. 6 and 7). In this case, the respective roller cutout 32 on the pendulum flange 12 and the assigned roller cutout 32 on the absorber mass 14 are assigned to each other in such a way, as has especially been shown previously in FIG. 4, so that the areas 39 of the roller cutouts 32 of the pendulum flange 12 and of the absorber mass 14, the radius Rₛ and Rₘ, respectively are enlarged in these areas 39, starting from the neutral position and/or location 33, lie opposite each other. Analogously, the areas 40 of the roller cutouts 32 of the pendulum flange 12 and of the absorber mass 14 with radii Rₛ and Rₘ, respectively, which are reduced in this area 40 starting from the neutral position and/or location 33, are opposite each other. Also, like the cutouts 32 of the pendulum flange and of the absorber mass in FIGS. 4 to 7, a respective cutout 32, e.g., of the pendulum flange in FIG. 2, is formed of a circle or curve deviating from a circular segment using radius increases and radius reductions R_{mΔ} and/or R_{sΔ} from a neutral position (oscillation angle φ=0°).

The design of an oscillation absorber arrangement and/or of a centrifugal pendulum includes, e.g., at least one of the following points:
the oscillation length is variable or constant, depending on the oscillation angle;
the distance of the oscillation center is variable or constant depending on oscillation angle;
the turning angle of the absorber mass is variable or constant depending on oscillation angle;
a specific path shape of the mass center of gravity with a specific turning curve of the absorber mass corresponds to the desired absorber order curve;
the path shape and the turning of the mass center of gravity is achieved by paths of, e.g., two points of the absorber mass;
the absorber masses are suspended, e.g., by means of two pins and bearings mounted on them in the roller cutouts, e.g., of the pendulum disk and/or the pendulum flange, whereby the cutouts in the pendulum disk and/or in the pendulum flange have the design or the curve of the path shapes of two points of the absorber mass;
the absorber masses are, e.g., suspended by means of rollers in the roller cutouts of the pendulum disk and/or the pendulum flange, for example, by means of two rollers;
the cutouts or roller cutouts are formed, e.g., by curves each deviating from a circle or a circular segment; and,
the respective cutout or roller cutout is non-symmetrical and/or it runs along a path and/or motion path that is not symmetrical.

As previously described, a centrifugal pendulum or an oscillation absorber device or arrangement is suggested, in which the desired absorber order curve achieved by a specific path shape and a turning curve of the mass center of gravity and in turn by variation of geometry variables over the oscillation angle. The present embodiments, as previously described using FIGS. 1 to 7, can be combined with each other, and especially individual characteristics thereof

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### LIST OF REFERENCE NUMERALS

10 Oscillation absorber device
12 Pendulum flange
14 Absorber mass
16 Pendulum
18 Path
20 Point
22 Point
24 Oscillation center
26 Center axis
28 Motion path (point 20)
30 Motion path (point 22)
32 Cutout
33 Neutral location or position
34 Pin
35 Outer contour
36 Bearing
37 Inner contour
38 Roller
39 Area of the cutout with enlarged radius
40 Area of the cutout with reduced radius

What is claimed is:

1. A centrifugal pendulum (10) for a shaft rotating around an axis, comprising:
a pendulum flange (12) on which at least two axially opposite absorber masses (14) connected to each other by way of a spacer element (34, 36, 38) are mounted; and,
at least one cutout (32) in the absorber masses (14) and/or the pendulum flange (12) of the centrifugal pendulum (10) in which the spacer element of the absorber mass (14) is guided;
wherein, starting at a neutral position (33), the cutout (32) is formed by a circle or a curve deviating from a circular segment by a radius increase of the cutout (32) in an area (39) starting from the neutral position (33) and a radius reduction of the cutout (32) in another area starting from the neutral position (33).

2. The centrifugal pendulum recited in claim 1, wherein the two absorber masses (14) and the pendulum flange (12) of the centrifugal pendulum (10) each has a cutout (32), wherein the cutout (32) of the pendulum flange (12) is arranged with respect to the cutout (32) of the absorber mass (14) in such a way that the area (39) of the cutout of the pendulum flange (12) which has a radius increase starting from the neutral position (33) lies opposite the area (40) of the cutout (32) of the absorber mass (14) that has a radius reduction starting from the neutral position (33).

3. The centrifugal pendulum recited in claim 2, wherein the two absorber masses (14) and the pendulum flange (12) of the centrifugal pendulum (10) each have two cutouts (32), whereby especially the two cutouts (32) of the pendulum flange (12) are arranged mirror-inverted with respect to each other and the two cutouts (32) of the respective absorber mass (14) are arranged mirror-inverted with respect to each other.

4. The centrifugal pendulum recited in claim 1, wherein the pendulum flange (12) has two cutouts (32), whereby a respective motion path (28, 30) of two points (20, 22) of the absorber mass (14) in the cutouts (32) can be determined using the following equations:
x_{Ri}=0.5B(cos βᵢ−1)+lᵢ sin φᵢ+(H−Yₛ)sin βᵢ
x_{Ri}=0.5B(l−cos βᵢ)+lᵢ sin φᵢ+(H−Yₛ)sin βᵢ
y_{Ri}=0.5B sin βᵢ−Lᵢ−lᵢ cos φᵢ−(H−Yₛ)cos βᵢ+H
y_{Ri}=0.5B sin βᵢ+Lᵢ+lᵢ cos φᵢ+(H−Yₛ)cos βᵢ−H, wherein φ₁ is the oscillation angle of the pendulum, β₁ is the turning angle of the mass and/or absorber mass (mass element); Yₛ is the distance of mass center of gravity (mass element); L₁ is the distance of the oscillation center; l₁ is the oscillation length of the mass and/or absorber mass; H is the distance of the first or second point of the absorber mass from the oscillation center; and, B is the distance of the first and second point from each other.

5. The centrifugal pendulum recited in claim 1, wherein the spacer element (34, 38) is a pin element (34), a roller (38) or a stepped roller (38).

6. The centrifugal pendulum recited in claim 1, wherein the spacer element (34, 38) has an additional bearing (36).

7. The centrifugal pendulum recited in claim 1, wherein the cutout (32) is designed in such a way that the absorber mass (14) can execute a translational and a rotary motion, whereby the at least one cutout (32) especially has a non-symmetrical curve or path curve.

8. The centrifugal pendulum recited in claim 1, wherein a turning angle (β) of the absorber mass (14) and/or a distance (L) of an oscillation center (24) of the centrifugal pendulum (10) and/or an oscillation length (1) of the absorber mass (14) depend on an oscillation angle (φ) of the centrifugal pendulum (10).

9. The centrifugal pendulum recited in claim 1, wherein a diameter of the spacer element (34, 36, 38) is smaller than a width of the cutout (32) in which the spacer element (34, 36, 38) is guided.

10. A drive train, especially of a vehicle, which has a centrifugal pendulum (10) as recited in claim 1.

11. A drive train, especially of a vehicle, which has a centrifugal pendulum (10) as recited in claim 2.

12. A drive train, especially of a vehicle, which has a centrifugal pendulum (10) as recited in claim 3.

13. A drive train, especially of a vehicle, which has a centrifugal pendulum (10) as recited in claim 4.

14. A drive train, especially of a vehicle, which has a centrifugal pendulum (10) as recited in claim 5.

15. A drive train, especially of a vehicle, which has a centrifugal pendulum (10) as recited in claim 6.

16. A drive train, especially of a vehicle, which has a centrifugal pendulum (10) as recited in claim 7.

17. A drive train, especially of a vehicle, which has a centrifugal pendulum (10) as recited in claim 8.

18. A drive train, especially of a vehicle, which has a centrifugal pendulum (10) as recited in claim 9.
